(19) United States
(12) Patent Application Publication
(10) Pub. No.: US 2009/0161113 A1
(43) Pub. Date: Jun. 25, 2009

(54) INTEGRATED OPTOELECTRONIC SYSTEM FOR AUTOMATIC CALIBRATION OF AN OPTICAL DEVICE

(76) Inventors: Young-Kai Chen, Berkeley Heights, NJ (US); Sanjay Patel, New Providence, NJ (US); Mahmoud Rasras, Berkeley Heights, NJ (US); Kun-Yii Tu, Clifton, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 11/960,017

(22) Filed: Dec. 19, 2007

(51) Int. Cl. G01B 9/02

(52) U.S. Cl. 356/477

(57) ABSTRACT

An apparatus and method for automated calibration of an optical device are disclosed. The apparatus is an integrated optoelectronic system that includes input and output optical waveguides, a tunable optical device, an optical source, an optical detector, and an electronic controller formed on a single substrate. The tunable optical device has one or more tuning elements for varying one or more characteristics of the device. The optical source is coupled to the input waveguide for providing a calibration signal to the device. The optical detector is coupled to the output optical waveguide for measuring an intensity of the optical signal output by the device in response to receiving the calibration signal. The electronic controller is configured to perform a calibration of the device by varying a parameter of each tuning element and to receive intensity measurements of the optical signal output by the device as a function of the varied parameter.

### GOVERNMENT CONTRACT

This invention was made with Government support under Contract No. HR0011-05-C-0027 under the EPIC program of a DARPA contract. The Government has certain rights in this invention.

### FIELD OF THE INVENTION

The present invention generally relates to an apparatus and method for automatic calibration of optical devices.

### BACKGROUND

Calibration of optical devices such as optical filters is usually performed by measuring their frequency response using a laser and an optical spectrum analyzer, leading to information of various parameters such as frequency response, group delay and polarization dependent loss.

### BRIEF SUMMARY

Embodiments relate to an apparatus and method for automatic calibration of optical devices.

One embodiment provides an integrated optoelectronic system that includes input and output optical waveguides, a tunable optical device, an optical source, an optical detector, and an electronic controller formed on a single substrate. The tunable optical device, which is coupled to the input and output optical waveguides, has one or more tuning elements for varying one or more characteristics of the tunable optical device. The optical source is coupled to the input waveguide for providing a calibration signal to the tunable optical device. The optical detector is coupled to the output optical waveguide for measuring an intensity of the optical signal output by the tunable optical device in response to receiving the calibration signal. The electronic controller is coupled to the optical detector and the one or more tuning elements of the tunable optical device. The electronic controller is configured to perform a calibration of the tunable optical device by varying a parameter of each of the one or more tuning elements and to receive intensity measurements of the optical signal output by the device as a function of the varied parameter.

Another embodiment provides a method of calibrating a tunable optical device. The method involves providing an integrated optoelectronic planar structure that includes a planar substrate with input and output optical waveguides, an optical source coupled to the input optical waveguide, an optical detector coupled to the output optical waveguide, and an electronic controller formed on the planar structure. The optical device has a tuning element for varying a characteristic of the device. In this method, the controller is operated to: (a) provide a calibration signal from the optical source to the input optical waveguide, (b) adjust a parameter of the tuning element to vary the characteristic of the device, and (c) receive measurements of an intensity of an optical signal at the output waveguide as a function of the parameter.

### BRIEF DESCRIPTIONS OF THE FIGURES

Some embodiments can be readily understood by considering the following Detailed Description of Illustrative Embodiments in conjunction with the accompanying drawings, in which:

FIG. 1 is a schematic illustration of one embodiment of an integrated optoelectronic system configured for automatic calibration;

FIG. 2A is a plot of the laser intensity as a function of heater power applied to a phase shifter in a ring resonator of FIG. 1;

FIG. 2B-2C are schematic illustrations of several plots similar to that of FIG. 2A at different heater powers applied to the coupler of the ring resonator of FIG. 1;

FIG. 3A is a schematic illustration of another embodiment of an integrated optoelectronic system configured for automatic calibration of a 4th order pole/zero filter;

FIG. 3B is a schematic illustration of another embodiment of the integrated optoelectronic system for automatic calibration of a 4th order pole/zero filter; and

FIG. 4 is a diagram showing a method of automatic calibration of an optical device.

To facilitate understanding, identical reference numerals have been used, where possible, to designate identical elements that are common to the figures.

### DETAILED DESCRIPTION OF ILLUSTRATIVE EMBODIMENTS

Embodiments provide an integrated optoelectronic system and a method for automatic calibration of a tunable optical device in the system.

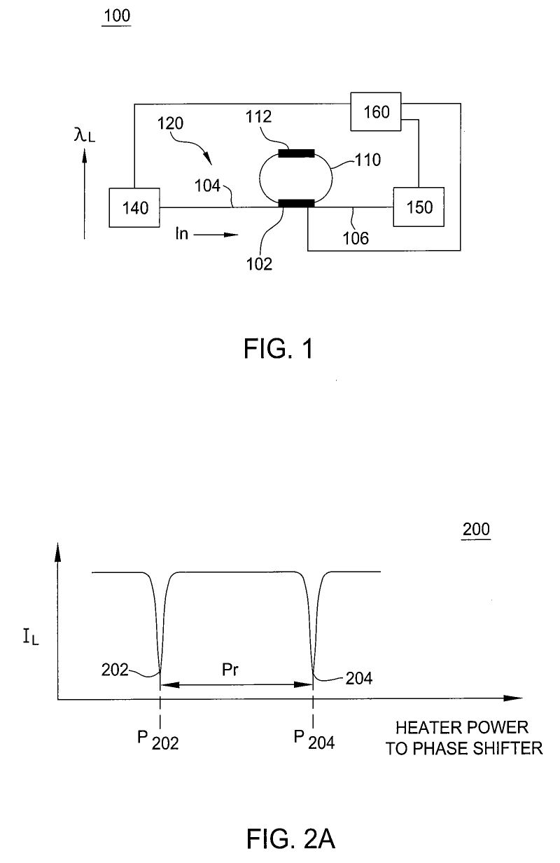

FIG. 1 is a schematic illustration of one embodiment of an integrated optoelectronic system 100, which includes a waveguide structure 120 coupled to an optical source 140, a detector 150 and a controller 160 formed on a single substrate. The substrate may be fabricated, e.g., from silicon-based or germanium-based materials. The controller 160 is used for initiating and controlling the automatic calibration of a tunable optical device in the waveguide structure 120.

In this example, the waveguide structure 120 includes a single stage ring resonator 110 (the tunable optical device) coupled via a tunable coupler 102 to input and output waveguides 104, 106 of the waveguide structure 120. The input waveguide 104 couples the optical source 140 to an input of the tunable optical coupler 102, and the output waveguide 106 couples the detector 150 to an output of the tunable optical coupler 102. A phase shifter 112 is provided for tuning the resonant frequency of the ring resonator 110.

In one embodiment, both the phase shifter 112 and the tunable coupler 102 are thermo-optic components, whose parameters or characteristics, e.g., phase shift or coupling coefficients, can be tuned or adjusted by applying power to a heater such as a resistive element heater. The resonant wavelengths of the ring resonator 110 can be modeled by kλₖ=2πrη, where r is a radius of the ring, η is an effective refractive index of the waveguide in the resonator and k is an integer greater than or equal to one. Here, the effective refractive index η includes any effect of the phase shifter 112 and/or coupler 102. Thus, the resonant wavelengths of the ring resonator 110 can be changed by changing the effective refractive index η of the of the phase shifter 112 and/or coupler 102 by adjusting the amount of heat applied to the phase shifter 112 and/or the coupler 102. Thus, the variable phase shifter 112 and variable coupler 102 enable the tuning of the wavelength of the ring resonator 110.

In other embodiments, the phase shifter 112 and coupler 102 may be tuned by alternative phase tuning techniques such as carrier injection in a PIN junction or reversed biased PIN junction (where P denotes a p-doped junction, I denotes an intrinsic type layer, and N denotes an n-doped junction). In these embodiments, the interaction of light with carriers (i.e., electrons and holes) changes the phase of the propagating light, and the phase change value is related to the density and distribution of the carriers inside the waveguide in which the light is propagating.

The optical source 140 is generally a monochromatic source, e.g., a laser for providing a fixed frequency or tunable frequency output (λₒ) to serve as a calibration signal. The detector 150 is coupled to the output waveguide segment 106 for monitoring the intensity of the signal output by the optical device being calibrated. The controller 160 is operatively connected to the optical source 140, phase shifter 112, the coupler 102 and the detector 150 for controlling the automated calibration or tuning of the ring resonator 110, e.g., via a feedback control loop.

Calibration of the ring resonator 110 is done by monitoring the transmittance of the signal intensity through the waveguide structure 120 as a function of the heater powers applied to the phase shifter 112 and/or the tunable coupler 102.

To calibrate the ring resonator 110, the coupler 102 is set so that at least a portion of a signal from the optical source 140, e.g., a known laser tone frequency, is coupled to the ring resonator 110. When the response of the ring resonator 110 is varied by tuning the phase shifter 112, the transmittance of the laser intensity through the waveguide structure 120 is modulated by the frequency response of the ring resonator 110. When the phase shifter 112 is tuned to a resonant wavelength proximate the laser wavelength λₒ, the laser signal intensity monitored at the detector 150 decreases because the loss experienced by the laser light coupled into the ring resonator 110 effectively results in a signal loss in the output waveguide 106. The loss of the signal is proportional to the ring's round trip loss.

Generally, the phase shift in the ring resonator 110 is linearly proportional to the phase shifter's applied heater power. Therefore, the phase of the ring resonator can be expressed as:

φ=(P/Pᵣ)2π−φₒ Eq. (1)

where P is the applied heater power, Pᵣ is the required power to shift the phase by 2π, and φₒ is the initial phase of the ring resonator. In general, φₒ=(Pₒ/Pᵣ)2π, where Pₒ is the power required to position the ring's resonant wavelength at the laser tone frequency. As an example, if a ring resonator has an initial resonance condition at the laser tone wavelength (λ₀), then φₒ=0.

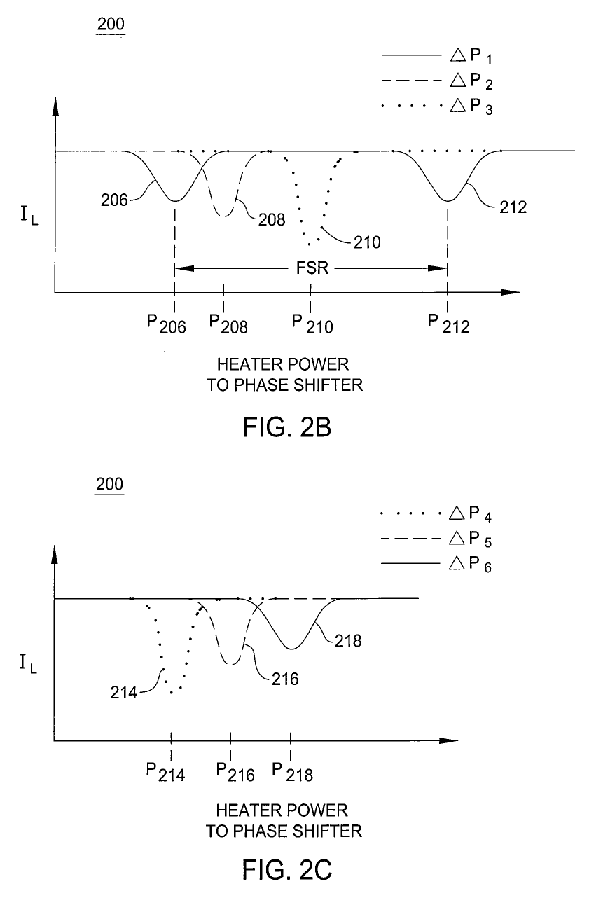

This is illustrated in FIG. 2A, which is a plot of the laser intensity I_{L} at the detector 150 versus the heater power applied to the phase shifter 112, with the coupler 102 fixed at a non-zero coupling setting. The tunable coupler 102 of the ring resonator 110 affects both the phase φ and the coupling coefficient κ (also referred to as the coupling strength or coupling ratio) of the ring resonator 110. The dip 202 in the laser intensity corresponds to a first resonant condition, and the second dip 204 corresponds to a second resonant condition. The difference between power settings P₂₀₂ and P₂₀₄ (corresponding to resonant dips 202 and 204) is the amount of power, Pᵣ, required to introduce a phase shift of 2π to the ring resonator, or to move or tune the resonant frequency by one free spectral range (FSR) of the ring resonator 110.

Since the phase shift introduced by the phase shifter 112 is typically about proportional to the heater power, the phase of the ring resonator 110 can be calibrated as a function of the power applied to the heater by tuning the phase shifter 112 through a range corresponding to at least one FSR. Based on the approximate linear relationship between the phase and the applied heater power, the initial phase (φ₀) of the ring resonator can be determined.

The coupling coefficient κ (also referred to as the coupling strength or coupling ratio) can be determined from the characteristics of the resonant dip (e.g., width, depth and round trip loss) using the following relation for the ring frequency response H(z):

H(z)=e^{-jφ}ₒ[ρe^{+jφ}ₒ−z⁻¹]/[1+(ρe^{+jφ}ₒ)z⁻¹] Eq. (2)

where z=exp [−j(2π)(P/Pᵣ)], φₒ is the initial phase of the resonator, and κ defines the ring coupling strength where ρ=(1−κ)^{0.5}, and j=\sqrt{−1}. The free spectral range of a ring resonator is related to the ring unit delay (T), which can be calculated from T=(Ln_{g})/c, where L is the ring's round trip length, c is the speed of light, and n_{g} is the group index. The ring resonator has a frequency response that is periodic. The FSR or period of the frequency response is about equal to 1/T, which is approximately inversely proportional to L, i.e., the optical path length in the resonator 110.

Since the depth and width of the resonant dip are determined by the coupling ratio and the ring's round trip loss, by fitting the measured shape of the resonance curve against the ring transfer function, e.g., against |H(z)|², the ring coupling ratio κ can be determined.

The calibration of the ring resonator 110, which involves obtaining the parameters Pᵣ and φₒ in the phase relationship (Equation 1) and the coupling ratio κ, is further discussed below.

With the tunable coupler 102 set at a given heater power (and thus, a given coupling ratio), the laser intensity is monitored by detector 150 while tuning the phase shifter 112 through, at least, a wavelength range corresponding to one free spectral range (FSR) as described above. The parameters Pᵣ, and φₒ in the phase relationship and coupling ratio are determined as discussed above, based on relationships such as Equations (1) and (2).

This procedure is then repeated for a range of other heater power settings for the tunable coupler 102, e.g., at predetermined heater power increments (ΔP), and the corresponding phase shifts (due to change in the coupling ratios) of the resonator and shapes of the resonant dips are determined for these power settings.

FIG. 2B schematically illustrates several expected curves for the signal intensity I_{L} measured by the detector 150 as a function of the heater power applied to the tunable phase shifter 112 during calibration measurements. Each curve is generated by setting the coupler 102 at a different heater power, and scanning the heater power applied to the phase shifter 112. For example, the curves in FIG. 2B are obtained by setting the heater power for the coupler 102 at ΔP₁, ΔP₂ and ΔP₃ respectively, and scanning the power applied to phase shifter 112. Resonant dips 206, 208 and 210 are obtained at corresponding heater powers of P₂₀₆, P₂₀₈, and P₂₁₀ to the phase shifter 112. In this figure, only the curve corresponding to the ΔP₁ power setting of coupler 102 is shown as having two resonant dips 206 and 212. Here, the other two curves are shown as having only one resonant dip only for simplicity of illustration.

Since the resonant dip is a periodic function of the heater power, the measurement may be performed, e.g., by varying the power setting of the coupler 102 through at least one complete period of that periodic variation. During a frequency sweep, when the shape of the dip corresponds again to the initially observed shape, the measurements are considered complete, and can be terminated.

This is illustrated in FIG. 2C, which shows additional curves of the signal intensity I_{L} as a function of the heater power applied to the tunable phase shifter 112. For example, these curves may be obtained at larger heater power settings ΔP₄, ΔP₅ and ΔP₆ to the coupler 102 compared to those of ΔP₁, ΔP₂ and ΔP₃ shown in FIG. 2B. The approximate periodic nature of the placement and form of the resonant dips is illustrated by dips 214, 216 and 218, which have substantially similar shapes to the corresponding dips 210, 208 and 206.

Thus, if the calibration procedure starts with power setting ΔP₁ for coupler 102 (giving dip 206), and proceeds until a power setting ΔP₆ for which a similarly shaped dip 218 appears, i.e., substantially the same shape as the dip 206, the measurement is complete, and can be terminated. The coupling ratio K can then be plotted as a function of the heater power of the tunable coupler 102.

The above-described calibration procedure can be implemented and adapted for use in different optical systems with a variety of optical components or devices.

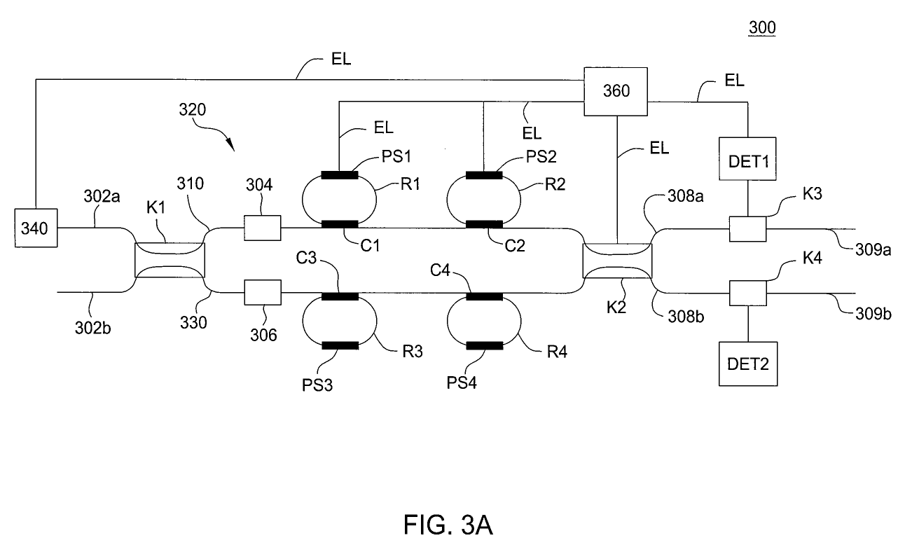

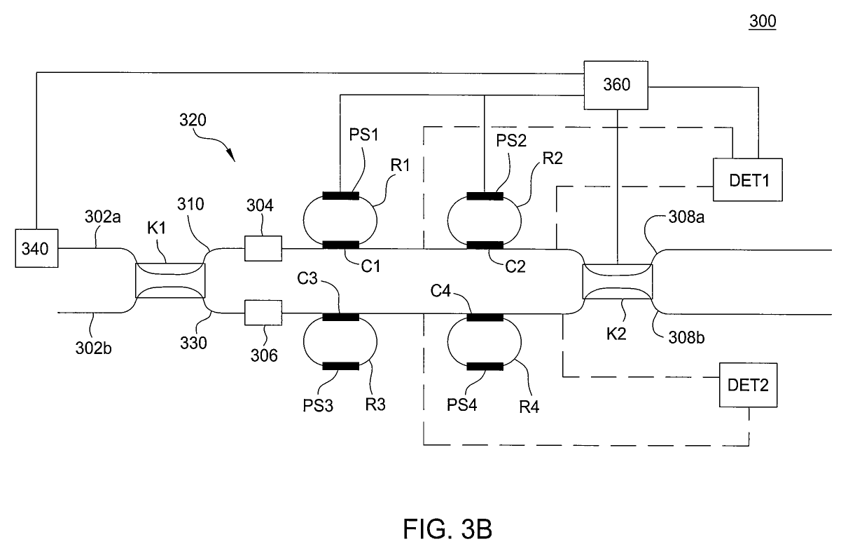

One example is given in FIG. 3A, which is a schematic illustration of one embodiment of an integrated optoelectronic system 300 with a tunable 4^{th} order pole/zero filter 320 for providing a narrow passband frequency response. The filter 320 is formed by a Mach-Zehnder (MZ) interferometer with a tunable input coupler K1, two substantially identical ring resonators in each arm 310, 330, and a tunable output coupler K2. Couplers K1, K2 are preferred to be tunable, e.g., either thermally or by other phase tuning techniques such as carrier injection or reversed biased PIN junctions. Each ring resonator in the filter 320 is configured as an all pass filter (APF). Other embodiments may generally have one or more substantially identical cascaded ring resonators in each arm.

The integrated optoelectronic system 300 is configured for automatic calibration of the filter 320, and includes an optical source 340, e.g., a monochromatic laser, serving as a calibration source, and at least one detector (e.g., DET1 and/or DET2) for monitoring the signal output from the filter 320. An electronic controller 360 is operatively coupled by electrical lines (EL) to various electrical and tunable components in the system 300. The electronic controller 360 controls the electrical and tunable optical component(s) and performs automatic calibration of one or more tunable optical component(s). For the sake of illustration, only a few electrical lines EL between controller 360 and several of the electrical and tunable optical components are shown in FIG. 3A. However, it is understood that the controller 360 may also be connected to other electrical and tunable components and may also be connected to associated electronics for implementing the calibration procedure.

By routing the optical beat tone of the optical source 340 near the respective center wavelengths of the individual optical components, the detected response will be indicative the amount of the offset and proper feedback adjustment can be obtained to control the components in order to maintain wavelength stability. In this way, self-calibration of individual components can be performed to maintain the correct center frequency according to the calibration tones.

The calibration source 340 is coupled to one input 302a of the tunable coupler K1. The coupling ratio of coupler K1 can be adjusted so that different fractions of an input signal can be coupled respectively to the upper (or top) arm 310 and the lower (or bottom) arm 330 of the MZ interferometer. The other input 302b of the tunable coupler K1 is used for coupling a signal in an optical communication network, e.g., data signal, to the filter 320.

Ring resonators R1 and R2 are coupled to the upper arm 310 of the MZ structure via respective tunable couplers C1 and C2, while ring resonators R3 and R4 are coupled to the lower arm 330 of the MZ structure via respective tunable couplers C3 and C4. The filter order is determined by the total number of rings present in the structure.

Tunable coupler K2 is provided at the output end of the MZ structure for varying the coupling ratio between two signal paths 308a and 308b.

As shown in FIG. 3A, tunable coupler K3 is used to direct a signal in the upper path 308a, in variable proportions, to a first detector DET1 at one output. The other output of the coupler K3 can be used for directing the optical signal for transmission to the optical communications network. Another tunable coupler K4 is used to direct a signal in the lower path 308b, in variable proportions, to a second detector DET2 at one output. The other output of the coupler K4 can be used for directing the optical signal for transmission to the optical communications network.

During operation, the input coupler K1 is configured as a 3 dB splitter and the output coupler K2 is configured as a 3 dB combiner. An input data signal from the optical communications network is coupled to the input 302b of the coupler K1. The filtered signal is coupled to either of the output arms, 308a or 308b of output coupler K2, and directed vie coupler K3 or K4 to a subsequent element of the optical network.

The filter response of filter 320 can be tailored by tuning the zeros and/or poles of the individual resonators R1, R2, R3 and R4. This is accomplished by changing the coupling strength (K) into the resonators using the corresponding couplers C1, C2, C3 and C4. In addition, the resonance frequencies of the rings are tuned to the appropriate positions by adjusting the respective phase shifters PS1, PS2, PS3 and PS4. The APFs in one MZ arm are set to have the complex conjugate response of the APFs on the other arm. The output combiner K2 adds and subtracts the two APF responses. The resultant filter response is periodic with the free spectral range (FSR) of the ring resonators.

The frequency-dependent response of the filter can be understood using the complex z-transformation presentation, where z=e^{jΩT}, Ω is the frequency, and T is the ring's round trip unit time delay. The combined response of the APFs is the convolution of the individual ring frequency responses, which, in this case, is given by:

$$\begin{matrix}{A}_{1} ( z ) = {e}^{jβ} {\prod }_{k = 1}^{2} \frac{{e}^{- {jφ}_{k}} ( - {e}^{{jφ}_{k}} {ρ}_{k} + γ {z}^{- 1} )}{1 - {ρ}_{k} {γe}^{- {jφ}_{k}} {z}^{- 1}} & Eq . ( 3 ) \\ {A}_{2} ( z ) = {e}^{- jβ} {\prod }_{k = 1}^{2} \frac{{e}^{{jφ}_{k}} ( - {e}^{- {jφ}_{k}} {ρ}_{k} + γ {z}^{- 1} )}{1 - {ρ}_{k} {γe}^{{jφ}_{k}} {z}^{- 1}} & Eq . ( 4 )\end{matrix}$$

where A₁(z) and A₂(z) are the z representations of the upper and lower APF responses, respectively. Here, β is a real constant. Equations (3) and (4) describe the APF response in terms of the ring resonator's coupling ratios κₖ=1−ρₖ², ring resonator's phase φ_{κ}, and ring resonator's round trip delay path transmittance ratio γ, where ρₖ/γ and 1/(ρₖγ) define the magnitudes of the zeros and poles.

The phases in the upper and lower MZ arms are set to β-φₜₒₜ and φₜₒₜ-β, where φₜₒₜ=Σφ_{κ}, the sum of the APF phases in the upper arm. Using the known decomposition algorithm described in Madsen, “Efficient Architectures for Exactly Realizing Optical Filters with Optimum Bandpass Designs,” IEEE PTL, vol. 10, 1136-1138 (1998), the magnitude and phase of each pole/zero is then determined for a desired passband response.

In this example, the 4th order filter 320 is entirely implemented in a CMOS foundry using silicon-on-insulator (SOI) wafers with a buried oxide thickness of about 3 μm and waveguide core thickness of about 0.2 μm. A conservative bend radius of about 25 μm is used and the APFs are designed with a FSR of 16.5 GHz. The total filter area is 10 mm×1 mm, which is almost 25 times smaller than the same filter would be if it were made in standard silica with 0.8% step index contrast.

To configure the passband response of the filter 320, thermo-optic phase shifters are used to set the coupling ratios and phases of the APFs. These thermo-optic heaters are fabricated using standard CMOS metallization. Since silicon has a thermo-optic coefficient that is an order of magnitude larger than silica, only 20 mW is needed to obtain a π phase change across a waveguide.

Calibration of the 4^{th} order pole-zero filter 320 involves separately calibrating each of the ring resonators. That is, except for the resonator under calibration, all other resonators in the system have to be “decoupled” from the optical path being used for calibration. The calibration procedure for one ring resonator in the integrated optoelectronic system 300 is discussed below, and should be repeated for all the other resonators individually in order to calibrate the 4^{th} order filter 320.

At the beginning of the calibration procedure, all the tunable couplers K1, K2, K3 and K4 are set to some initial settings, e.g., the zero power bias settings. Due to fabrication variability of the couplers, these settings may be arbitrary, and thus, the initial coupling ratio (which depends on the phase difference between the two arms) may be random. For the purpose of this example, detector DET1 is selected for use in detecting the light output from coupler K2, which means that a goal during the calibration steps is to maximize the signal intensity (denoted by I_{D1}) at detector DET1, while minimizing intensity (denoted by I_{D2}) at detector DET2.

Initially, couplers K3 and K4 are adjusted to maximize both I_{D1} and I_{D2}. To direct the calibration light only to one arm of the structure, coupler K1 is adjusted from its initial position until I_{d1} is maximized. With coupler K1 at this setting, coupler K2 is then adjusted to further maximize I_{D1}, which will also correspond to minimizing I_{D2}. Both couplers K1 and K2 are adjusted iteratively until a maximum value of I_{D1} is obtained, while minimizing I_{D2}.

To ascertain that the calibration light is propagating through only one of the two arms 310, 330 of the MZ structure, one of the phase shifters 304 and 306 can be adjusted from its initial position. If the intensity I_{d1} is not affected by adjusting phase shifter 304 (or 306), then one can be assured that the calibration light is propagating through only the upper arm 310 or the lower arm 330. This condition may correspond to the calibration signal propagating via the through-through port of the tunable couplers K1 and K2 of the MZ, cross-through, or cross-cross.

One can ascertain which arm the light is propagating through by adjusting any one of the couplers C1, C2, C3 or C4, and monitoring the intensity I_{D1} for any change when one of the couplers (C1-C4) is adjusted. If the intensity I_{D1} changes upon adjusting C1 or C2, then the light is propagating in the upper arm 310.

Each ring resonator R1 and R2 can be separately calibrated using the method previously described in connection with the single resonator of FIG. 1.

Thus, to calibrate the phase shift introduced by the phase shifter PS1, the coupler C2 for resonator R2 is set at its non-coupling point, and coupler C1 is set at a certain non-zero coupling point—i.e., with some calibration signal coupled in to the resonator R1. With the resonator R2 decoupled from the upper arm 310, the optical signal that has been coupled to the resonator R1 and exiting coupler C1 will propagate through couplers K2 and K3 to detector DET1.

By monitoring the signal intensity at detector DET1 and applying heat to the phase shifter PS1 through at least an entire range of the FSR of resonator R1, the phase of the phase shifter PS1 can be obtained. The coupling ratio for the tunable coupler C1 can be obtained by analyzing the characteristics of the resonance dip, e.g., the depth and width of the dip and resonator loss can be measured as a function of the heater power applied to the tunable coupler C1, as previously described.

After R1 and R2 are calibrated, the calibration signal from source 340 is switched to the other arm 330 by adjusting coupler K1 while keeping coupler K2 at the same setting. This will direct the calibration signal to propagate via the second arm 330. In this case, a maximum signal intensity will be detected by the second detector DET2. Resonators R3 and R4 can then be separately calibrated following the procedures described above.

In operation, the input coupler K1 is configured as a 3-dB splitter, and the output coupler K2 is configured as a 3-dB combiner. The input splitter K1 divides the power equally between the upper and lower arms 310 and 330 of the MZ interferometer.

To locate the 3 dB point of couplers K1, K2 for the MZ interferometer, one obtains set points for the couplers K1, K2 at which detectors DET1 and DET2 measure equal signal intensities. This can be done, for example, by shifting each resonator (R1, R2, R3 and R4) off their respective resonant locations for the calibration signal, and adjusting one coupler to obtain equal signal intensities at detectors DET1 and DET2, while the other coupler is switched fully to one arm.

The resonant frequencies and the exact coupling ratio delays are then set for each resonator by adjusting C1-C4 and PS1-PS4 based on a predetermined filter response, e.g., the bandwidth, band rejection and inband and out of band ripple. Some background relating to the filter can be found in references such as Madsen, “Efficient Architectures for Exactly Realizing Optical Filters with Optimum Bandpass Designs”, IEEE Photonics Tech. Lett., vol. 10, p. 1136-1138 (August 1998) and Rasras et al., “Demonstration of a Fourth-Order Pole-Zero Optical Filter Integrated Using CMOS Processes,” J. Lightwave Tech., vol. 25, p. 87-92 (January 2007), both of which are herein incorporated by reference in their entirety.

The relative phase of the MZ arms can be tuned by adjusting the input and output couplers K1 and K2 to ensure that a passband is produced. Couplers K3 and K4 are then tuned to minimize the signal intensities at both detectors DET1 and DET2 to ensure that the passband through the filter will propagate to the remaining part of the optical transmission circuit via outputs 309a or 309b.

Although FIG. 3A shows the two detectors DET1 and DET2 being configured to detect a portion of the signal output after the coupler K2, other configurations can also be implemented. FIG. 3B shows a configuration in which the detector DET1 is used to detect at least a portion of the signal output from ring R1, e.g., by providing a “tap” at a location of the upper arm 310 between resonator rings R1 and R2. Similarly, the same detector DET1 can be used to detect the signal output from resonator R2 by using a tap at output of resonator R2, but before the coupler K2. Similarly, detector DET2 can be used to detect the respective signals from resonators R3 and R4 by directing at least a portion of each signal from the corresponding outputs of these components, as indicated by the dashed lines in FIG. 3B.

For these embodiments, the system 300 can be fabricated with appropriate taps or branches in the waveguide structure 320 and the signal portions from respective resonators R1, R2, R3 and R4 can be routed via software to the appropriate detector DET1 and/or DET2 during calibration. In one embodiment, the tapped portion directed to either detector DET1 or DET2 may be between about 1% to about 5% of the signal output from the resonator under calibration.

In another embodiment, a single detector, e.g., DET1, may also be used for monitoring the signals for calibrating all four resonators R1-R4. For example, this configuration may be used in a situation in which couplers K1 and K2 are completely switchable such that the signal intensity can be directed exclusively to detector DET1 by appropriate setting of these couplers (i.e., without any signal being directed to the output 308b of coupler K2).

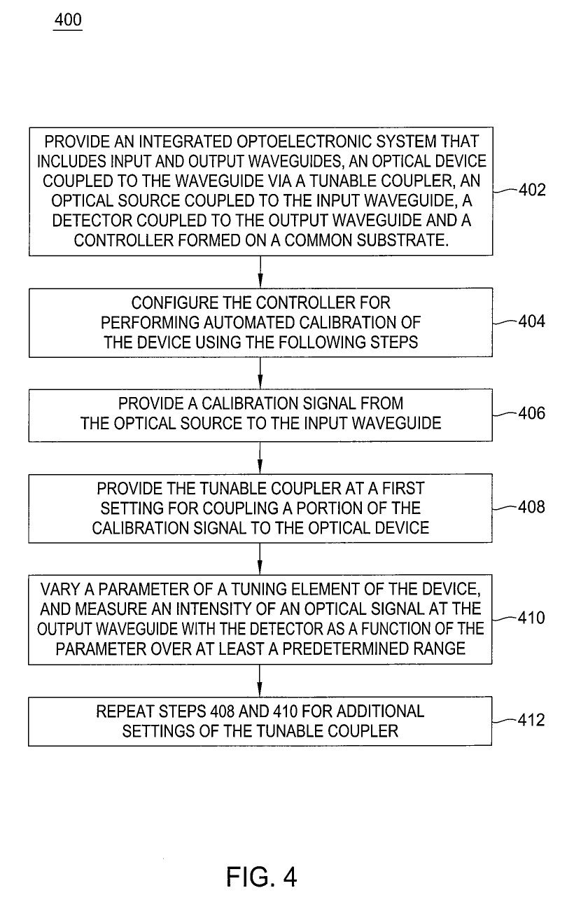

FIG. 4 is a diagram illustrating a method 400 for performing an automated calibration of an optical device. The method 400 starts at step 402, in which an integrated optoelectronic system is provided. The system includes input and output waveguides, an optical device, an optical source coupled to the input waveguide, a detector coupled to the output optical waveguide and a controller formed on a common substrate. The optical device is coupled to the input and output waveguides via a tunable coupler, and the optical device has a tuning element with an adjustable parameter for varying a characteristic of the device.

As shown in step 404, the controller is configured for performing a calibration of the device according to an automated procedure that includes steps 406 through 412.

In step 406, a calibration signal is provided from the optical source to the input waveguide. In step 408, the tunable coupler is provided at a first setting for coupling a portion of the calibration signal to the optical device. In step 410, a parameter of the tuning element is varied, and an intensity of the optical signal at the output of the waveguide is measured as a function of the parameter over at least a predetermined range. In step 412, steps 408 and 410 are repeated for different coupling ratios or settings of the tunable coupler. The measurements end when the tunable coupler setting has completed a full cycle of the coupling ratio.

The calibration method can be stored as a program in a computer readable medium that can be accessed by the controller to initiate and perform the automatic calibration, without the need for human intervention or control.

In one embodiment, the method is used for calibrating a waveguide structure similar to that illustrated in FIG. 3A. The waveguide structure includes an input coupler, a Mach-Zehnder (MZ) interferometer and an output coupler. The input coupler has a first output coupled to a first arm of the MZ interferometer and a second output coupled to a second arm of the MZ interferometer, and the output coupler has a first input coupled to the first arm and a second input coupled to the second arm. The first and second arm of the MZ interferometer each has one or more optical devices coupled thereto, and each optical device has a phase shifter for tuning a phase of the device, and an associated tunable coupler for varying a coupling strength between the device and the respective arm.

In one embodiment, the first arm of the MZ interferometer has the same number of substantially identical optical devices as the second arm. Each optical device is a ring resonator with a phase shifter that is used for varying the frequency of the resonator, and a tunable coupler for coupling the resonator to the arm of the MZ interferometer. Both the phase shifter and the tunable coupler are thermo-optic components that can be tuned by applying heat to the component.

The automated calibration method involves coupling a calibration signal from the optical source to the input coupler of the MZ interferometer, and directing the calibration signal to propagate only in one arm of the MZ interferometer and only to one optical device under calibration (i.e., decoupling the other devices from the arm being used as the calibration path). The signal intensity exiting the selected arm of the MZ interferometer is coupled via the output coupler to the detector, and monitored as a function of the phase of the first optical device.

To calibrate a ring resonator, the tunable coupler is first set at a fixed coupling ratio, and the calibration signal intensity is monitored as the phase shifter is tuned through a range corresponding to at least one free spectral range of the resonator. This procedure is repeated by setting the tunable coupler at different coupling ratios, and the calibration signal intensity is monitored as the phase shifter is tuned through a range corresponding to at least one free spectral range of the resonator. The phase of the resonator can be obtained based on the phase shift measurements as a function of heater power applied to the phase shifter (or other appropriate parameters of the phase shifter, depending on the tuning mechanism). The coupling ratio can be determined by fitting the observed shape of the resonant dip to the resonator transfer function. The determined coupling ratios can then be plotted against the heater power (or other appropriate parameter) of the tunable coupler. The procedure can be repeated for each ring resonator in the system.

With the built-in calibration source and signal detection capabilities, embodiments of the integrated optoelectronic system allow automated calibration to be performed without a need for human intervention. The system can be configured for automatic calibration at predetermined times or based on specific needs, including for example, as part of routine maintenance or diagnostics. Although embodiments have been discussed with respect to automatic calibration, the system and method can also be adapted for implementing automatic correction of spectral responses of individual optical components.

While the foregoing is directed to some embodiments, other and further embodiments may be devised without departing from the basic scope thereof, and the scope thereof is determined by the claims that follow.

1. An integrated optoelectronic system, comprising:
input and output optical waveguides;
a tunable optical device coupled to the input and output optical waveguides, the tunable optical device having one or more tuning elements for varying one or more characteristics of the tunable optical device;
an optical source coupled to the input waveguide for providing a calibration signal to the tunable optical device;
an optical detector coupled to the output optical waveguide for measuring an intensity of the optical signal output by the tunable optical device in response to receiving the calibration signal; and
an electronic controller coupled to the optical detector and the one or more tuning elements of the tunable optical device and configured to perform a calibration of the tunable optical device by varying a parameter of each of the one or more tuning elements and to receive intensity measurements of the optical signal output by the device as a function of the varied parameter;
wherein the optical waveguides, the optical device, the optical source, the optical detector and the electronic controller are formed on a single substrate.

2. The system of claim 1, wherein the optical waveguides, optical source, optical detector and the electronic controller and single substrate form part of a monolithic planar structure.

3. The system of claim 2, wherein the one or more tuning elements includes a tunable phase shifter.

4. The system of claim 2, wherein the tunable optical device includes a ring resonator that is coupled to the optical waveguides via a tunable coupler.

5. The system of claim 2, wherein the tunable optical device includes an optical filter, the filter including a Mach-Zehnder interferometer having a pair of arms, each arm having one or more ring resonators optically coupled thereto.

6. The system of claim 1, wherein the characteristic of the device is selected from a group consisting of a resonant frequency and a coupling strength.

7. The system of claim 1, further comprising a feedback control loop coupling the electronic controller, the optical detector and the one or more tuning elements.

8. The system of claim 6, wherein the electronic controller is configured to one of automatically set the parameter of the tuning element at a predetermined setting and automatically calibrate the tunable device.

9. The system of claim 2, wherein the single substrate comprises one of silicon wafer-substrate and germanium-based wafer-substrate.

10. The system of claim 1, wherein the integrated optoelectronic system includes complementary metal oxide semiconductor (CMOS) structures.

11. A method of calibrating a tunable optical device, comprising:
providing an integrated optoelectronic planar structure comprising a planar substrate, the substrate including input and output optical waveguides, an optical source coupled to the input optical waveguide, an optical detector coupled to the output optical waveguide, and an electronic controller formed thereon; the optical device having a tuning element for varying a characteristic of the device; and
operating the controller to:
(a) provide a calibration signal from the optical source to the input optical waveguide,
(b) adjust a parameter of the tuning element to vary the characteristic of the device, and
(c) receive measurements of an intensity of an optical signal at the output waveguide as a function of the parameter.

12. The method of claim 11, wherein the optical device is a ring resonator and the adjusting involves varying a resonant frequency of the ring resonator over a free spectral range of the ring resonator.

13. The method of claim 12, further comprising:
setting the parameter of the tuning element at a non-resonant position; and
adjusting a tunable coupler of the ring resonator to the waveguides and measuring the intensity of the signal at the output optical waveguide as a function of a coupling of the tunable coupler.

14. The method of claim 13, wherein the tuning element and the tunable coupler are thermo-optically controlled components.

15. The method of claim 11, wherein the tunable optical device is an optical filter, the filter including a Mach-Zehnder interferometer having a pair of arms, each of the arms having one or more ring resonators optically coupled thereto.
